(19) United States
(12) Patent Application Publication
(10) Pub. No.: US 2026/0161555 A1
(43) Pub. Date: Jun. 11, 2026

(54) MEMORY MANAGEMENT METHOD AND MEMORY CONTROLLER

(71) Applicant: Hefei Kaimeng Technology Co., Ltd., Anhui (CN)

(72) Inventors: Zhi WANG, Anhui (CN); Tsung-Lin Wu, Anhui (CN); Qiao ZHU, Anhui (CN); Dongsheng Guan, Anhui (CN); Yu Zhang, Anhui (CN)

(73) Assignee: Hefei Kaimeng Technology Co., Ltd., Anhui (CN)

(21) Appl. No.: 19/386,187

(22) Filed: Nov. 11, 2025

(30) Foreign Application Priority Data
Dec. 9, 2024 (CN) 202411802730.3

(51) Int. Cl. G06F 12/02

(52) U.S. Cl. CPC G06F 12/0253; G06F 12/0246; G06F 2212/7201

(57) ABSTRACT

A memory management method and a memory controller are provided. The memory management method adapted for a storage device configured with a rewritable non-volatile memory module comprises: obtaining a valid count of each of a plurality of virtual blocks, wherein each virtual block comprises one or more physical blocks of the rewritable non-volatile memory module; obtaining a pre-GC state of each virtual block according to the valid count of each virtual block; determining an update order of a valid data bitmap of each virtual block according to the pre-GC state of each virtual block; and selecting a target virtual block according to the update order of the valid data bitmap of each virtual block, to update a target valid data bitmap of the target virtual block by using a logical-to-physical index list corresponding to the target virtual block and a logical-to-physical mapping table corresponding to the logical-to-physical index list.

### CROSS-REFERENCE TO RELATED APPLICATION

This application claims the priority benefit of China application serial no. 202411802730.3, filed on Dec. 9, 2024. The entirety of the above-mentioned patent application is hereby incorporated by reference herein and made a part of this specification.

### BACKGROUND

### Technical Field

The present disclosure relates to the technical field of memory technology, and more particularly, to a memory management method and a memory controller.

### Description of Related Art

Non-volatile memory refers to a computer memory in which the stored data does not disappear after the power is turned off. It has the advantages of data non-volatility, power saving, small size, and no mechanical structure, and is widely used in various electronic devices.

A common non-volatile memory is a memory configured with NAND Flash (such as a solid-state drive), which has the characteristics of high read/write speed and not requiring a mechanical structure for data access.

In a NAND flash storage device, as data is frequently written and updated, a large amount of invalid data is generated in the storage space. To optimize the utilization efficiency of the storage space, the storage device needs to organize the valid data in storage blocks through a garbage collection (GC) mechanism. The garbage collection process may be divided into foreground garbage collection (Foreground GC) and background garbage collection (Background GC). Among them, the foreground garbage collection is a garbage collection operation that is forced to be performed during a host data writing process due to insufficient remaining storage space. Since the foreground garbage collection is performed simultaneously with the host writing, it is necessary to frequently look up and update a mapping table during the garbage collection process, which not only consumes a lot of system resources but also significantly affects the performance of the storage device. Therefore, how to improve the efficiency of the foreground garbage collection is a technical problem that current storage devices urgently need to solve.

### SUMMARY

In view of the above problems, the present disclosure provides a memory management method and a memory controller, which significantly improve the efficiency of foreground garbage collection by introducing a valid data bitmap and combining it with a pre-GC state mechanism.

One or more embodiments of the present disclosure provide a memory management method, adapted for a storage device configured with a rewritable non-volatile memory module. The method comprises: obtaining a valid count of each of a plurality of virtual blocks, wherein each of the virtual blocks comprises one or more physical blocks of the rewritable non-volatile memory module; obtaining a pre-GC state of each of the virtual blocks according to the valid count of each of the virtual blocks; determining an update order of a valid data bitmap of each of the virtual blocks according to the pre-GC state of each of the virtual blocks; selecting a target virtual block from the plurality of virtual blocks according to the update order of the valid data bitmap of each of the virtual blocks, to update a target valid data bitmap of the target virtual block by using a logical-to-physical index list corresponding to the target virtual block and a logical-to-physical mapping table corresponding to the logical-to-physical index list.

In one or more embodiments of the present disclosure, the method further comprises: determining a garbage collection order of each of the virtual blocks according to the pre-GC state of each of the virtual blocks.

In one or more embodiments of the present disclosure, the step of obtaining the pre-GC state of each of the virtual blocks comprises: comparing the valid count of each of the virtual blocks with a plurality of thresholds of different sizes to determine a threshold interval in which the valid count of each of the virtual blocks is located; determining the pre-GC state of each of the virtual blocks according to the threshold interval of each of the virtual blocks, if the valid count of a virtual block is greater than a maximum threshold among the plurality of thresholds, determining the pre-GC state of the virtual block to be a minimum pre-GC state; if the valid count of a virtual block is smaller than a minimum threshold among the plurality of thresholds, determining the pre-GC state of the virtual block to be a maximum pre-GC state; wherein a first virtual block corresponding to the minimum pre-GC state is determined to not need to update a corresponding first valid data bitmap, and a second virtual block corresponding to the maximum pre-GC state is determined to need to preferentially update a corresponding second valid data bitmap.

In one or more embodiments of the present disclosure, a number of the plurality of thresholds is 3, and the pre-GC state comprises a first pre-GC state, a second pre-GC state, a third pre-GC state, and a fourth pre-GC state, wherein a valid count corresponding to the first pre-GC state is greater than a first threshold, a valid count corresponding to the second pre-GC state is greater than a second threshold and smaller than the first threshold, a valid count corresponding to the third pre-GC state is greater than a third threshold and smaller than the second threshold, and a valid count corresponding to the fourth pre-GC state is smaller than a third threshold, wherein the first threshold is the maximum threshold, the third threshold is the minimum threshold, the first threshold is greater than the second threshold, and the second threshold is greater than the third threshold.

In one or more embodiments of the present disclosure, the logical-to-physical index list is used for recording an identifier of one or more logical-to-physical mapping tables associated with a corresponding virtual block, wherein a physical address of valid data stored in the corresponding virtual block is recorded in one of the one or more logical-to-physical mapping tables.

One or more embodiments of the present disclosure provide a memory controller for controlling a storage device configured with a rewritable non-volatile memory module. The memory controller comprises: a memory interface control circuit, for electrically connecting to the rewritable non-volatile memory module; a data management circuit, electrically connected to a connection interface circuit of the storage device, for receiving data and commands from a host system via the connection interface circuit; a buffer memory, for buffering data; and a processor, electrically connected to the memory interface control circuit, the data management circuit, and the buffer memory. The processor is configured to: obtain a valid count of each of a plurality of virtual blocks, wherein each of the virtual blocks comprises one or more physical blocks of the rewritable non-volatile memory module; obtain a pre-GC state of each of the virtual blocks according to the valid count of each of the virtual blocks; determine an update order of a valid data bitmap of each of the virtual blocks according to the pre-GC state of each of the virtual blocks; and select a target virtual block from the plurality of virtual blocks according to the update order of the valid data bitmap of each of the virtual blocks, to update a target valid data bitmap of the target virtual block by using a logical-to-physical index list corresponding to the target virtual block and a logical-to-physical mapping table corresponding to the logical-to-physical index list.

In one or more embodiments of the present disclosure, the method further comprises: determining a garbage collection order of each of the virtual blocks according to the pre-GC state of each of the virtual blocks.

In one or more embodiments of the present disclosure, the step of obtaining the pre-GC state of each of the virtual blocks comprises: comparing the valid count of each of the virtual blocks with a plurality of thresholds of different sizes to determine a threshold interval in which the valid count of each of the virtual blocks is located; determining the pre-GC state of each of the virtual blocks according to the threshold interval of each of the virtual blocks, if the valid count of a virtual block is greater than a maximum threshold among the plurality of thresholds, determining the pre-GC state of the virtual block to be a minimum pre-GC state; if the valid count of a virtual block is smaller than a minimum threshold among the plurality of thresholds, determining the pre-GC state of the virtual block to be a maximum pre-GC state; wherein a first virtual block corresponding to the minimum pre-GC state is determined to not need to update a corresponding first valid data bitmap, and a second virtual block corresponding to the maximum pre-GC state is determined to need to preferentially update a corresponding second valid data bitmap.

In one or more embodiments of the present disclosure, a number of the plurality of thresholds is 3, and the pre-GC state comprises a first pre-GC state, a second pre-GC state, a third pre-GC state, and a fourth pre-GC state, wherein a valid count corresponding to the first pre-GC state is greater than a first threshold, a valid count corresponding to the second pre-GC state is greater than a second threshold and smaller than the first threshold, a valid count corresponding to the third pre-GC state is greater than a third threshold and smaller than the second threshold, and a valid count corresponding to the fourth pre-GC state is smaller than a third threshold, wherein the first threshold is the maximum threshold, the third threshold is the minimum threshold, the first threshold is greater than the second threshold, and the second threshold is greater than the third threshold.

In one or more embodiments of the present disclosure, the logical-to-physical index list is used for recording an identifier of one or more logical-to-physical mapping tables associated with a corresponding virtual block, wherein a physical address of valid data stored in the corresponding virtual block is recorded in one of the one or more logical-to-physical mapping tables.

In one or more embodiments of the present disclosure, the valid data bitmap comprises a plurality of bits, each of the bits corresponds to a data area of a preset size in the virtual block, and is used for indicating whether data in the data area is valid data.

Based on the above, the memory management method and the memory controller provided by the embodiments of the present disclosure may significantly reduce mapping table lookup overhead during foreground garbage collection by pre-establishing and updating a valid data bitmap; utilize a pre-GC state mechanism to manage virtual blocks hierarchically, so that garbage collection may preferentially process virtual blocks with a higher proportion of invalid data, thereby improving recovery efficiency of storage space; and pre-update the valid data bitmap when the storage device is idle, avoiding real-time update overhead during garbage collection and effectively improving response speed of the storage device under high load conditions.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram of a host system and a storage device according to an embodiment of the present disclosure.

FIG. 2 is a flowchart of a memory management method according to an embodiment of the present disclosure.

FIG. 3 is a schematic diagram of updating a logical-to-physical index list for write data according to an embodiment of the present disclosure.

FIG. 4 is a schematic diagram of updating a valid data bitmap according to an embodiment of the present disclosure.

FIG. 5 is a schematic diagram of a pre-GC state classification mechanism according to an embodiment of the present disclosure.

FIG. 6 is a schematic diagram of a virtual block pre-GC state table according to an embodiment of the present disclosure.

FIG. 7 is a flowchart of a memory management method according to another embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numerals are used in the drawings and the description to refer to the same or similar parts.

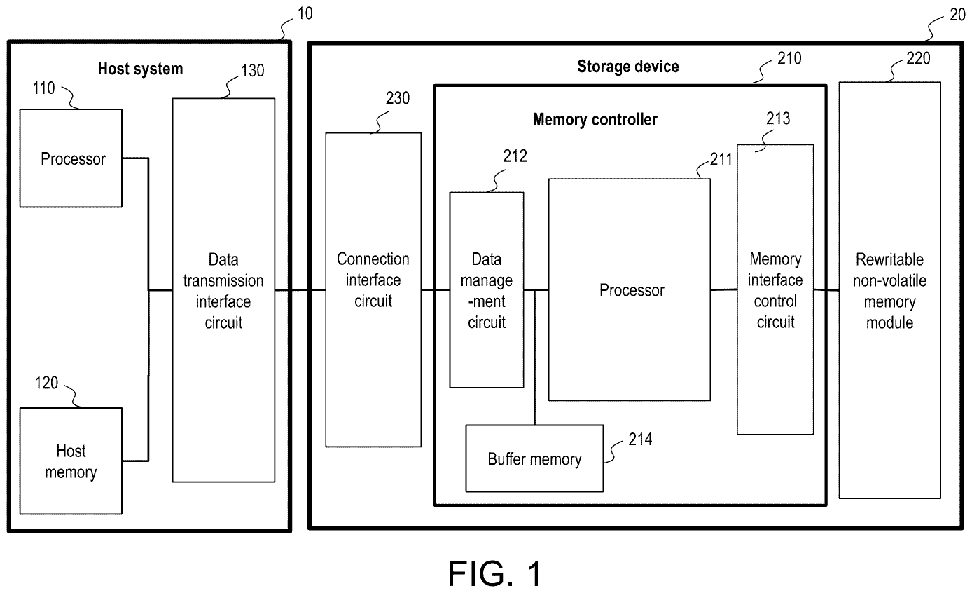

FIG. 1 is a schematic block diagram of a host system and a storage device according to an embodiment of the present disclosure. Referring to FIG. 1, the host system 10 is, for example, a personal computer, a notebook computer, or a server. The host system 10 includes a processor 110 (also referred to as a second processor), a host memory 120, and a data transfer interface circuit 130. In this embodiment, the processor 110 is coupled (also referred to as electrically connected) to the host memory 120 and the data transfer interface circuit 130. In another embodiment, the processor 110, the host memory 120, and the data transfer interface circuit 130 are electrically connected to each other through a system bus. In this embodiment, the processor 110, the host memory 120, and the data transfer interface circuit 130 may be disposed on a motherboard of the host system 10.

The storage device 20 includes a memory controller 210, a rewritable non-volatile memory module 220, and a connection interface circuit 230. The memory controller 210 includes a processor 211 (also referred to as a first processor), a data management circuit 212, and a memory interface control circuit 213.

In this embodiment, the host system 10 is electrically connected to the storage device 20 through the data transfer interface circuit 130 and the connection interface circuit 230 of the storage device 20 to perform data access operations. For example, the host system 10 may store data to the storage device 20 or read data from the storage device 20 via the data transfer interface circuit 130.

In this embodiment, a number of the data transfer interface circuit 130 may be one or more. Through the data transfer interface circuit 130, the motherboard may be electrically connected to the storage device 20 in a wired or wireless manner. The storage device 20 may be, for example, a USB flash drive, a memory card, a Solid State Drive (SSD), or a wireless memory storage device. The wireless memory storage device may be, for example, a memory storage device based on various wireless communication technologies, such as a Near Field Communication (NFC) memory storage device, a Wi-Fi memory storage device, a Bluetooth memory storage device, or a Bluetooth Low Energy memory storage device (e.g., iBeacon). In addition, the motherboard may also be electrically connected to various I/O devices such as a Global Positioning System (GPS) module, a network interface card, a wireless transmission device, a keyboard, a screen, and a speaker through the system bus.

In this embodiment, the data transfer interface circuit 130 and the connection interface circuit 230 are interface circuits compatible with the Peripheral Component Interconnect Express (PCI Express) standard. In addition, data transmission between the data transfer interface circuit 130 and the connection interface circuit 230 is performed using the Non-Volatile Memory express (NVMe) communication protocol.

In addition, in another embodiment, the connection interface circuit 230 may be packaged in a single chip with the memory controller 210, or the connection interface circuit 230 is disposed outside a chip including the memory controller 210.

In this embodiment, the host memory 120 is configured to temporarily store instructions or data executed by the processor 110. For example, in this embodiment, the host memory 120 may be a Dynamic Random Access Memory (DRAM), a Static Random Access Memory (SRAM), or the like. However, it is to be understood that the present disclosure is not limited thereto, and the host memory 120 may also be other suitable memories.

The memory controller 210 is configured to execute a plurality of logic gates or control instructions implemented in a hardware form or a firmware form and perform operations such as writing, reading, and erasing of data in the rewritable non-volatile memory module 220 according to commands from the host system 10.

More specifically, the processor 211 in the memory controller 210 is a hardware with computing capabilities, which is configured to control the overall operation of the memory controller 210. Specifically, the processor 211 is programmed by a plurality of control instructions/program codes, and when the storage device 20 is operating, these control instructions/program codes are executed to perform operations such as data writing, reading, and erasing. In addition, in this embodiment, the control instructions/program codes may further be executed to implement the memory management method provided by the present disclosure. The control instructions/program codes corresponding to the memory management may further be implemented as circuit units in a hardware form to implement the memory management method provided by the present disclosure.

It is worth mentioning that, in this embodiment, the processor 110 and the processor 211 are, for example, a Central Processing Unit (CPU), a micro-processor, or other programmable processing units (Microprocessor), a Digital Signal Processor (DSP), a programmable controller, an Application Specific Integrated Circuit (ASIC), a Programmable Logic Device (PLD), or other similar circuit components, and the present disclosure is not limited thereto.

In this embodiment, as described above, the memory controller 210 further includes the data management circuit 212 and the memory interface control circuit 213. It should be noted that operations performed by each component of the memory controller 210 may also be regarded as operations performed by the memory controller 210.

The data management circuit 212 is electrically connected to the processor 211, the memory interface control circuit 213, and the connection interface circuit 230. The data management circuit 212 is configured to receive instructions from the processor 211 to perform data transmission. For example, reading data from the host system 10 (e.g., the host memory 120) via the connection interface circuit 230, and writing the read data to the rewritable non-volatile memory module 220 via the memory interface control circuit 213 (e.g., performing a write operation (also referred to as a host write operation) according to a write command (also referred to as a host write command) from the host system 10). As another example, reading data from one or more physical units of the rewritable non-volatile memory module 220 via the memory interface control circuit 213 (the data may be read from one or more memory cells in the one or more physical units), and writing the read data to the host system 10 (e.g., the host memory 120) via the connection interface circuit 230 (e.g., performing a read operation according to a read command from the host system 10). In another embodiment, the data management circuit 212 may also be integrated into the processor 211.

The memory interface control circuit 213 is configured to receive instructions from the processor 211 and cooperate with the data management circuit 212 to perform a write (also referred to as programming) operation, a read operation, or an erase (also referred to as erase) operation on the rewritable non-volatile memory module 220.

In addition, data to be written to the rewritable non-volatile memory module 220 is converted by the memory interface control circuit 213 into a format acceptable to the rewritable non-volatile memory module 220. Specifically, if the processor 211 is to access the rewritable non-volatile memory module 220, the processor 211 transmits a corresponding command sequence to the memory interface control circuit 213 to instruct the memory interface control circuit 213 to perform a corresponding operation. For example, these instruction sequences may include a write instruction sequence for instructing to write data, a read instruction sequence for instructing to read data, an erase instruction sequence for instructing to erase data, and corresponding instruction sequences for instructing various memory operations. These instruction sequences may include one or more signals, or data on a bus. These signals or data may include instruction codes or program codes. For example, the read instruction sequence includes information such as a read identifier, a memory address, and a physical address.

In the present disclosure, the memory controller 210 establishes a Logical-to-Physical address mapping table (also referred to as an L2P mapping table) and a Physical-to-Logical address mapping table (also referred to as a P2L mapping table) to record a mapping relationship between logical addresses of logical units (e.g., logical blocks, logical pages, or logical columns) configured for the rewritable non-volatile memory module 220 and physical addresses of physical units (e.g., physical erase units/physical blocks, physical pages, physical columns). In other words, the memory controller 210 may look up a physical unit to which a logical unit is mapped through the logical-to-physical address mapping table (also referred to as a logical-to-physical mapping table) (e.g., looking up a physical page to which a logical page is mapped; looking up a physical address to which a logical address is mapped), and the memory controller 210 may look up a logical unit to which a physical unit is mapped through the physical-to-logical address mapping table (also referred to as a physical-to-logical mapping table) (e.g., looking up a logical page to which a physical page is mapped; looking up a logical address to which a physical address is mapped).

The memory controller 210 also establishes data structures to record various types of mapping relationships, including: a virtual block mapping list for recording physical blocks corresponding to each virtual block, an L2P index list for recording L2P mapping tables associated with each virtual block, and a virtual block pre-GC state table for recording pre-GC states corresponding to all virtual blocks.

In an embodiment, the memory controller 210 further includes a buffer memory 214. The buffer memory is electrically connected to the processor 211 and is configured to temporarily store data and commands from the host system 10, data from the rewritable non-volatile memory module 220, or other system data for managing the storage device 20 (e.g., system data related to the present disclosure, such as various mapping tables, index tables, the virtual block mapping list, the L2P index list, and the virtual block pre-GC state table), so that the processor 211 may quickly access the data, commands, or system data from the buffer memory 214.

In an embodiment, the memory controller 210 reserves a specific area in the buffer memory 214 for storing various types of mapping tables and index information. The memory controller 210 performs hierarchical caching on these data according to access frequency and importance: storing frequently accessed mapping table information in a fast access area, and storing less frequently used information in a normal area. When a space of the buffer memory 214 is insufficient, the memory controller 210 preferentially writes the less frequently used information back to the rewritable non-volatile memory module 220. To improve data reliability, the memory controller 210 also periodically synchronizes important mapping information in the buffer memory 214 to the rewritable non-volatile memory module 220 and records synchronization timestamps, so as to be able to restore to a most recent valid state when a system abnormality occurs.

In an embodiment, the memory controller 210 establishes a plurality of data structures to record various types of mapping relationships. Specifically, the memory controller 210 establishes a virtual block mapping list (VB mapping list) for recording identification information of one or more physical blocks corresponding to each virtual block. In some embodiments, the virtual block mapping list may also include position information of the physical blocks within a corresponding virtual block, erase count information of each physical block, and a valid count of each virtual block. The memory controller 210 also establishes an L2P index list for recording an identifier of one or more logical-to-physical mapping tables associated with each virtual block. In addition, the memory controller 210 also establishes a virtual block pre-GC state table (VB Pre-GC state table) for recording a pre-GC state corresponding to all virtual blocks. In an embodiment, each entry of the virtual block pre-GC state table comprises: a virtual block identifier, a current valid count value, and other information.

In another embodiment, the memory controller 210 stores these data structures in a preset area in the buffer memory and periodically synchronizes an updated state thereof to the rewritable non-volatile memory module to ensure data persistence and consistency. In some embodiments, when the memory controller 210 is restarted, a latest state of these data structures may be restored from the rewritable non-volatile memory module, ensuring that the system may continue previous memory management operations.

The rewritable non-volatile memory module 220 is electrically connected to the memory controller 210 (the memory interface control circuit 213) and is configured to store data written by the host system 10.

In this embodiment, the rewritable non-volatile memory module 220 has a plurality of word lines, wherein each of the plurality of word lines is electrically connected to a plurality of memory cells, also referred to as columns (also referred to as physical columns). A plurality of columns on the same word line form a physical programming unit (also referred to as a physical page). Each physical page corresponds to a physical address for recording a location of data stored in the physical page. In addition, a plurality of physical pages may form a physical block (also referred to as a physical erase unit or a physical block). Each of a plurality of memory dies (chips) of the rewritable non-volatile memory module has a plurality of planes, and each of the planes has a plurality of physical blocks. It should be noted that the present disclosure is not limited to a size of each physical page and logical page.

A memory cell type (also referred to as a storage mode) may be used to represent a number of bits that each memory cell (also referred to as a storage unit) may store. Common types include Single-Level Cell (SLC) (each memory cell stores 1 bit), Multi-Level Cell (MLC) (each memory cell stores 2 bits), Triple-Level Cell (TLC) (each memory cell stores 3 bits), and the like. Different storage modes have differences in aspects such as storage density, read/write speed, and endurance, affecting the overall performance and characteristics of the flash memory.

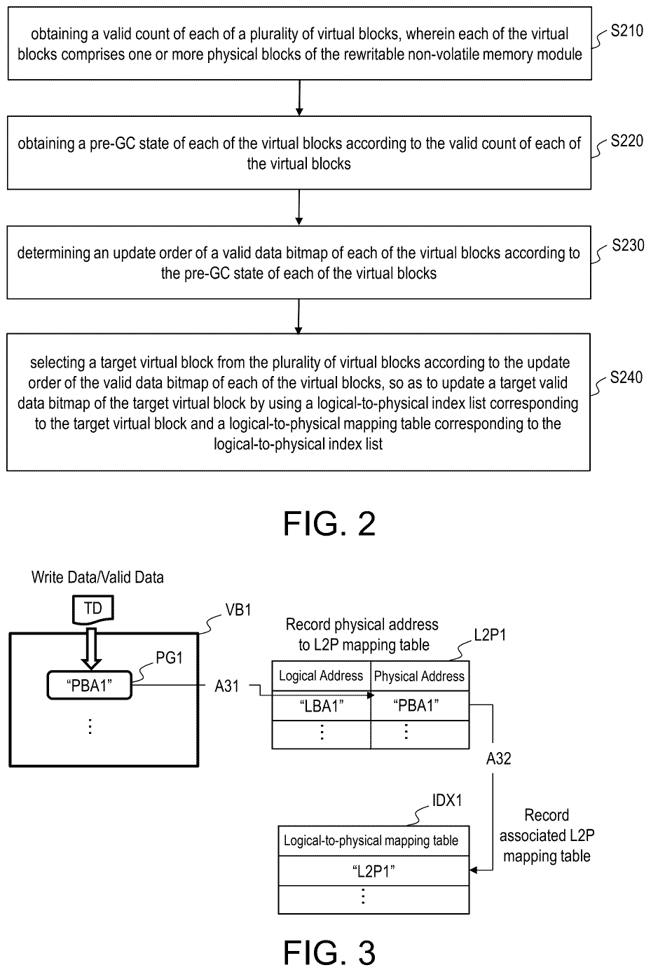

FIG. 2 is a flowchart of a memory management method according to an embodiment of the present disclosure.

Referring to FIG. 2, in an embodiment, the memory controller 210 performs a memory management method. Specifically, in step S210, the memory controller 210 obtains a valid count of each of a plurality of virtual blocks, wherein each of the virtual blocks comprises one or more physical blocks of the rewritable non-volatile memory module 220.

In an embodiment, the memory controller 210 may obtain the valid count of the virtual block in a plurality of ways. When the storage device 20 performs a write operation, the memory controller 210 maintains a valid count counter for counting a number of valid data in each virtual block in real time. Specifically, when performing the write operation, the memory controller 210 performs one of the following operations:
when write data is new data, the memory controller 210 increments the valid count counter of a target virtual block by 1; when the write data overwrites original data, the memory controller 210 first determines a source virtual block where the overwritten data is located according to the logical-to-physical mapping table, decrements the valid count counter of the source virtual block by 1, and then increments the valid count counter of the target virtual block by 1; and when data is deleted, the memory controller 210 decrements the valid count counter of a corresponding virtual block by 1.

In another embodiment, the memory controller 210 may periodically scan the logical-to-physical mapping table in the background to update the valid count by counting a number of occurrences of each virtual block in the mapping table. Although this method has a larger computational overhead, it may correct counting errors caused by system abnormalities.

In step S220, the memory controller 210 obtains the pre-GC state of each of the virtual blocks according to the valid count of each of the virtual blocks.

In an embodiment, when obtaining the pre-GC state of each of the virtual blocks, the memory controller 210 first compares the valid count of each of the virtual blocks with a plurality of preset thresholds to determine a threshold interval in which the valid count of the virtual block is located. Specifically, the memory controller 210 presets a plurality of thresholds of different sizes and arranges these thresholds in a descending order to divide a plurality of threshold intervals.

The memory controller 210 then determines the pre-GC state of each virtual block according to the threshold interval in which the valid count of the virtual block is located. When a valid count of a virtual block is greater than a maximum threshold among the plurality of thresholds, the memory controller 210 sets the pre-GC state of the virtual block to a minimum pre-GC state value. Conversely, when a valid count of a virtual block is smaller than a minimum threshold among the plurality of thresholds, the memory controller 210 sets the pre-GC state of the virtual block to a maximum pre-GC state value.

For example, when a first virtual block is determined to have the minimum pre-GC state, the memory controller 210 marks the first virtual block as not needing to update its corresponding first valid data bitmap. This is because a virtual block with the minimum pre-GC state usually has a higher proportion of valid data and does not need to undergo garbage collection temporarily. Conversely, when a second virtual block is determined to have the maximum pre-GC state, the memory controller 210 marks the second virtual block as needing to preferentially update its corresponding second valid data bitmap, because this type of virtual block has a higher proportion of invalid data and is more likely to be selected as a target for garbage collection.

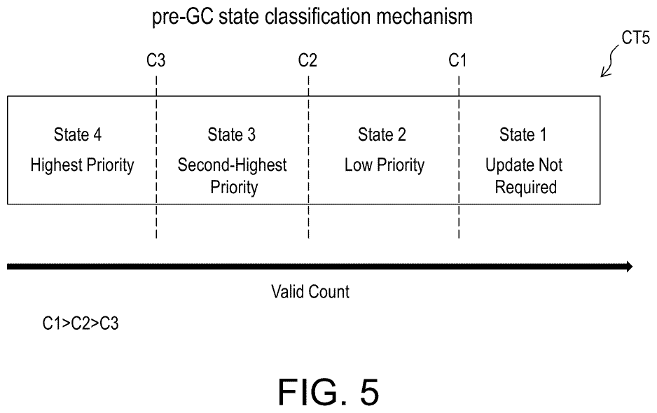

FIG. 5 is a schematic diagram of a pre-GC state classification mechanism according to an embodiment of the present disclosure.

Referring to FIG. 5, in an embodiment, the memory controller 210 implements a pre-GC state classification mechanism. As shown in chart CT5, an axis represents the valid count, and the memory controller 210 divides virtual blocks into different pre-GC states based on their valid count values.

In this embodiment, the memory controller 210 presets three thresholds, namely a first threshold (C1), a second threshold (C2), and a third threshold (C3), satisfying C1>C2 and C2>C3. The memory controller 210 uses these three thresholds to divide a value range of the valid count into four intervals, and maps these four intervals to four different pre-GC states, respectively.

Specifically, when the memory controller 210 detects that a valid count of a virtual block is greater than the first threshold C1, the memory controller 210 sets the pre-GC state of the virtual block to “State 1” and marks it as “Update Not Required”. This indicates that the virtual block has a higher proportion of valid data, and it is temporarily not necessary to update its valid data bitmap or perform garbage collection.

When the memory controller 210 detects that a valid count of a virtual block is smaller than the first threshold C1 but greater than the second threshold C2, the memory controller 210 sets the pre-GC state of the virtual block to “State 2” and marks it as “Low Priority”. This indicates that the valid data bitmap of the virtual block may be updated when system resources are sufficient.

When the memory controller 210 detects that a valid count of a virtual block is smaller than the second threshold C2 but greater than the third threshold C3, the memory controller 210 sets the pre-GC state of the virtual block to “State 3” and marks it as “Second-Highest Priority”. This indicates that the virtual block has a relatively high update priority.

When the memory controller 210 detects that a valid count of a virtual block is smaller than the third threshold C3, the memory controller 210 sets the pre-GC state of the virtual block to “State 4” and marks it as “Highest Priority”. This indicates that the virtual block has a higher proportion of invalid data, its valid data bitmap needs to be preferentially updated, and it may be preferentially selected for a garbage collection operation.

In an embodiment, in a specific implementation, the memory controller 210 may dynamically adjust specific values of these thresholds according to performance requirements and workload characteristics of the storage device 20. For example, in a high-performance requirement scenario, the values of these thresholds may be increased, so that more virtual blocks are classified into high-priority pre-GC states, so as to perform garbage collection more actively; in a low-power consumption scenario, the values of these thresholds may be lowered to reduce unnecessary garbage collection operations.

In addition, although the above example uses three thresholds to manage the classification of the pre-GC state, the present disclosure is not limited thereto. For example, the memory controller 210 may use more or fewer thresholds to manage the classification of the pre-GC state.

Returning to FIG. 2, next, in step S230, the memory controller 210 determines the update order of the valid data bitmap of each of the virtual blocks according to the pre-GC state of each of the virtual blocks.

In an embodiment, the memory controller 210 preferentially updates the valid data bitmap of a virtual block with a larger pre-GC state value. For example, when it is detected that the storage device 20 is in an idle state, the memory controller 210 first updates the valid data bitmap of a virtual block having the fourth pre-GC state, and then sequentially updates the valid data bitmaps of virtual blocks having the third pre-GC state and the second pre-GC state. As for a virtual block having the first pre-GC state, since its proportion of valid data is higher, its valid data bitmap may temporarily not be updated.

In step S240, the memory controller 210 selects a target virtual block from the plurality of virtual blocks according to the update order of the valid data bitmap of each of the virtual blocks, to update a target valid data bitmap of the target virtual block by using a logical-to-physical index list corresponding to the target virtual block and a logical-to-physical mapping table corresponding to the logical-to-physical index list.

In an embodiment, specifically, the memory controller 210 first finds all logical-to-physical mapping tables associated with the target virtual block through the logical-to-physical index list of the target virtual block. Then, the memory controller 210 checks whether a physical address of each data area in the target virtual block still exists in these mapping tables. If a physical address of a data area still exists in the mapping tables, a bit corresponding to the data area in the target valid data bitmap is set to a first value (e.g., 1); if a physical address of a data area does not exist in any of the mapping tables, a corresponding bit is set to a second value (e.g., 0). After the update is completed, the memory controller 210 stores the target valid data bitmap into the rewritable non-volatile memory module 220.

In an embodiment, when a predetermined condition is met (for example, when the storage device 20 is idle), the memory controller 210 may pre-update the valid data bitmap of each virtual block to provide a basis for rapid data validity judgment for a subsequent foreground garbage collection operation, so as to improve the efficiency of garbage collection.

FIG. 3 is a schematic diagram of updating a logical-to-physical index list for write data according to an embodiment of the present disclosure.

Referring to FIG. 3, in an embodiment, when write data TD is written to a virtual block VB1, the memory controller 210 updates the logical-to-physical index list.

Specifically, as shown by arrow A31, when the virtual block VB1 of the storage device 20 receives write data, the data is allocated a physical address “PBA1” and stored in the virtual block VB1. At the same time, the memory controller 210 needs to establish a mapping relationship from a logical address “LBA1” to the physical address “PBA1” for the data in the logical-to-physical mapping table L2P1. Specifically, the memory controller 210 creates a new entry in the logical-to-physical mapping table L2P1, which includes a logical address field and a physical address field, recording “LBA1” and “PBA1”, respectively.

Next, as shown by arrow A32, the memory controller 210 also needs to update the logical-to-physical index list IDX1. The logical-to-physical index list IDX1 is used for recording an identifier of one or more logical-to-physical mapping tables associated with the virtual block. In this embodiment, the memory controller 210 records the identifier “L2P1” of the logical-to-physical mapping table L2P1 in the index list IDX1, indicating that physical address information of valid data stored in the virtual block VB1 may be found in the mapping table L2P1. This also indicates that the valid data of the virtual block VB1 is associated with the logical-to-physical mapping table L2P1 recorded in the logical-to-physical index list IDX1.

In an embodiment, when establishing the logical-to-physical index list, the memory controller 210 adopts a hierarchical index structure. A first layer is a virtual block identifier, used for quickly locating a target virtual block; a second layer is a list of identifiers of all L2P mapping tables related to the virtual block. This hierarchical structure enables the memory controller 210 to quickly find all mapping information related to a specific virtual block.

The memory controller 210 updates the L2P index list through the following steps: when writing new data, the memory controller 210 first checks whether a target virtual block of the data already has a corresponding entry in the index list. If not, a new index entry is created; if it already exists, it is checked whether an L2P mapping table corresponding to the new data is already in a mapping table list of the virtual block. For a new mapping table that is not in the list, the memory controller 210 adds its identifier to the list.

When data mapping relationships of the same virtual block are scattered across a plurality of logical-to-physical mapping tables, the memory controller 210 records identifiers of all related mapping tables in an index list corresponding to the virtual block. This design enables the memory controller 210 to quickly locate and load all mapping tables that need to be queried (loaded into the buffer memory 214) during garbage collection, improving the efficiency of data validity judgment.

By maintaining this index list mechanism, the memory controller 210 may quickly determine which logical-to-physical mapping tables need to be checked in a subsequent garbage collection process, so as to improve the update efficiency of the valid data bitmap. When the memory controller 210 needs to update the valid data bitmap of a certain virtual block, it only needs to look up the index list corresponding to the virtual block to obtain the identifiers of all mapping tables that need to be checked, avoiding the overhead of traversing all mapping tables, thereby accelerating the speed of updating the valid data bitmap.

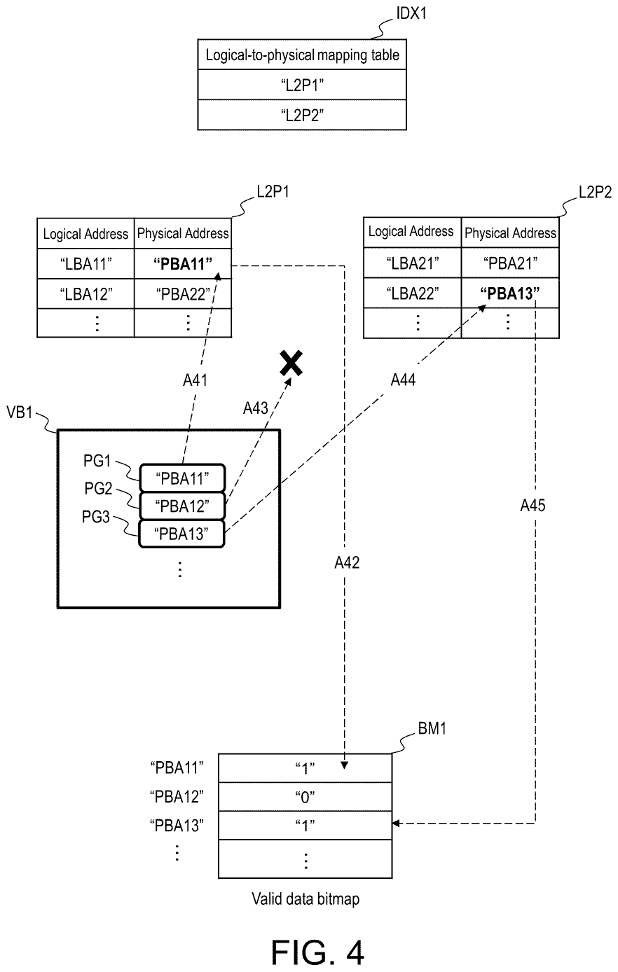

FIG. 4 is a schematic diagram of updating a valid data bitmap according to an embodiment of the present disclosure.

Referring to FIG. 4, in an embodiment, the memory controller 210 establishes and maintains a valid data bitmap BM1, which comprises a plurality of bits. Each bit corresponds to a data area of a preset size (e.g., PG1, PG2, PG3) in the virtual block VB1, and is used for indicating whether data in the data area is valid data. Specifically, when data stored in a certain data area is still valid (is valid data), the memory controller 210 sets a bit corresponding to the area to a first value (e.g., “1”); when data stored in a certain data area has become invalid (is not valid data), the memory controller 210 sets a bit corresponding to the area to a second value (e.g., “0”).

In an embodiment, when the storage device 20 is in an idle period (for example, when there are no host commands to be processed), the memory controller 210 performs a valid data bitmap update operation for the target virtual block VB1. First, the memory controller 210 accesses the logical-to-physical index list IDX1 corresponding to the target virtual block VB1, which records identifiers of all logical-to-physical mapping tables associated with the target virtual block VB1, including “L2P1” and “L2P2”.

The memory controller 210 accesses the logical-to-physical index list IDX1, which records the identifiers of the logical-to-physical mapping tables associated with the virtual block VB1, including “L2P1” and “L2P2”. Based on this, the memory controller 210 determines that it needs to load and check the mapping tables L2P1 and L2P2 to verify the validity of the data in the virtual block VB1.

After loading the mapping tables L2P1 and L2P2 into the buffer memory 214, the memory controller 210 checks whether the physical address of each data area of the virtual block exists in the physical addresses recorded by the mapping tables L2P1 and L2P2.

The memory controller 210 loads the related logical-to-physical mapping tables L2P1 and L2P2 according to the identifiers in the index list IDX1. As shown by arrow A41, the memory controller 210 checks that the first physical address “PBA11” of the first data area PG1 exists in the mapping table L2P1 and is associated with the logical address “LBA11”. Therefore, the memory controller 210 determines that the first physical address “PBA11” of the first data area PG1 stores valid data. Next, as shown by arrow A42, the memory controller 210 sets the first bit corresponding to the first data area in the valid data bitmap BM1 to “1” (also referred to as a first value).

As shown by arrow A43, the memory controller 210 checks that the second physical address “PBA12” of the second data area PG2 does not exist in any of the logical-to-physical mapping tables (indicated by a “×” mark in the figure). This indicates that the data stored at this physical address has become invalid (e.g., the physical address corresponds to invalid data), and therefore the memory controller 210 sets the second bit corresponding to the second data area in the valid data bitmap BM1 to “0 ” (also referred to as a second value).

As another example, as shown by arrows A44 and A45, for the physical address “PBA13” of the third data area PG3, the memory controller 210 finds its corresponding valid mapping relationship in the mapping table L2P2, wherein the physical address is associated with the logical address “LBA22”. This indicates that the data is still valid, and therefore the memory controller 210 sets the bit corresponding to the third data area in the valid data bitmap BM1 to “1”.

By analogy, the memory controller 210 may complete updating the valid data bitmap BM1 corresponding to the virtual block VB1. In this way, the memory controller 210 completes the update of the valid data bitmap BM1 of the virtual block VB1. The updated bitmap accurately reflects the validity state of each data area in the virtual block VB1, providing a reliable reference for subsequent garbage collection operations.

After completing the validity check of all data areas, the memory controller 210 stores the updated target valid data bitmap BM1 into the rewritable non-volatile memory module 220 for use in subsequent garbage collection operations. In this way, the storage device 20 is able to update the valid data bitmap in advance during idle time, thereby reducing overhead during garbage collection operations.

In an embodiment, in an actual implementation, the memory controller 210 may use batch processing to simultaneously check the validity of a plurality of physical addresses and update a plurality of bits in the valid data bitmap in a single operation, so as to improve update efficiency. In addition, the memory controller 210 may also maintain a checksum during the update process to verify the integrity of the updated valid data bitmap.

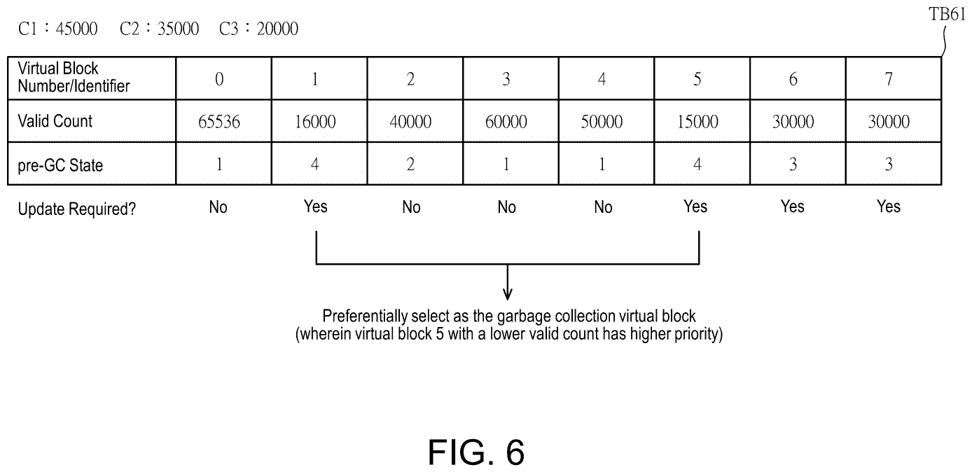

FIG. 6 is a schematic diagram of a virtual block pre-GC state table according to an embodiment of the present disclosure.

Referring to FIG. 6, in an embodiment, the memory controller 210 maintains a virtual block pre-GC state table TB61 for recording state information of a plurality of virtual blocks and guiding garbage collection operations.

The virtual block pre-GC state table TB61 includes a plurality of fields: a virtual block number/identifier field for uniquely identifying each virtual block; a valid count field for recording an amount of valid data in each virtual block; a pre-GC state field for indicating a pre-GC state value of the virtual block; and an “Update Required?” field for marking whether the valid data bitmap of the virtual block needs to be updated. In this embodiment, a virtual block with a pre-GC state of 1 is determined as not needing an update to its corresponding valid data bitmap because the total amount of its valid data exceeds a certain value, which in turn reduces resource overhead.

In this embodiment, the memory controller 210 presets three thresholds: a first threshold C1 (45000), a second threshold C2 (35000), and a third threshold C3 (20000). According to a comparison result between the valid count value and these thresholds, the memory controller 210 assigns a corresponding pre-GC state to each virtual block. For example, in FIG. 6, a virtual block with number “0” has a valid count of 65536, which is greater than C1, so its pre-GC state is set to “1”; while a virtual block with number “1” has a valid count of 16000, which is smaller than C3, so its pre-GC state is set to “4”, and so on.

The memory controller 210 determines whether to update the valid data bitmap of a virtual block according to the pre-GC state value. Specifically, when the pre-GC state value is “1”,since its proportion of valid data is higher, it is marked as “No”, indicating that no update is temporarily required; when the pre-GC state value is greater than “1”, it is marked as “Yes”, indicating that its valid data bitmap needs to be updated when the storage device 20 is idle.

When a foreground garbage collection needs to be performed during a host write operation, the memory controller 210 preferentially selects a virtual block with a maximum pre-GC state value (i.e., a state value of “4”) as a garbage collection target. As shown in FIG. 6, virtual block “1” and virtual block “5” have a pre-GC state of “4”, wherein virtual block “5” has a lower valid count (15000) and is therefore preferentially selected. If these virtual blocks have been processed, the memory controller 210 then selects a virtual block with a second-largest pre-GC state value (i.e., a state value of “3”), such as virtual block “6” and virtual block “7” in the figure, and so on. That is, the memory controller 210 may determine the garbage collection order of each of the virtual blocks according to the pre-GC state of each of the virtual blocks.

Taking FIG. 6 as an example, when a foreground garbage collection needs to be performed, the memory controller 210 first selects virtual block “5” (valid count 15000, pre-GC state “4”) as a garbage collection virtual block; then selects virtual block “1” (valid count 16000, pre-GC state “4”); and then selects virtual block “6” and virtual block “7” (both with a pre-GC state of “3”). This selection strategy based on the pre-GC state ensures that the garbage collection operation may preferentially process virtual blocks with a higher proportion of invalid data, thereby improving the recovery efficiency of storage space.

Through this pre-GC state table mechanism, the memory controller 210 is able to quickly identify and preferentially process the most suitable virtual blocks for GC during foreground garbage collection, significantly improving the efficiency of garbage collection.

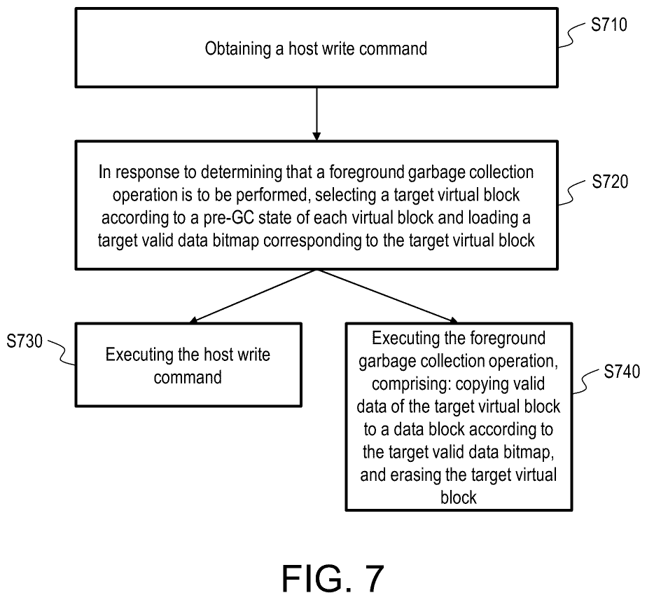

FIG. 7 is a flowchart of a memory management method according to another embodiment of the present disclosure.

Referring to FIG. 7, in an embodiment, the storage device 20 performs a memory management method combined with foreground garbage collection.

In step S710, the memory controller 210 obtains a write command sent by the host system 10. After obtaining the write command, the memory controller 210 needs to ensure that the storage device 20 has sufficient available space to complete the data write operation.

In step S720, in response to determining that a foreground garbage collection operation needs to be performed, the memory controller 210 selects a target virtual block according to the pre-GC state of each virtual block, and obtains a target valid data bitmap corresponding to the target virtual block. Specifically, the memory controller 210 preferentially selects a virtual block with a maximum pre-GC state value as a garbage collection virtual block, and if there are a plurality of virtual blocks with the same pre-GC state value, a processing order is further determined according to a magnitude of the valid count.

In an embodiment, the memory controller 210 may determine whether to perform a foreground garbage collection operation in a plurality of ways.

In a preferred embodiment, the memory controller 210 determines whether to perform the foreground garbage collection by monitoring an available space of the storage device 20. Specifically, the memory controller 210 presets a free space threshold, and when it is detected that the available space of the storage device 20 is smaller than the preset threshold, the foreground garbage collection operation is triggered. The free space threshold may be set according to a percentage of a total capacity of the storage device 20, for example, the garbage collection is triggered when the available space is lower than 10% of the total capacity.

In another embodiment, the memory controller 210 determines whether to perform the foreground garbage collection according to a comparison result between an amount of data of a write request and a current available space. When the memory controller 210 receives the write request from the host system 10, it calculates the amount of data to be written and compares it with the current available space. If the current available space is insufficient to accommodate the data to be written, the foreground garbage collection operation is initiated.

In yet another embodiment, the memory controller 210 determines whether to perform the garbage collection by evaluating a state distribution of the virtual blocks. Specifically, the memory controller 210 counts a number of virtual blocks whose pre-GC state is the fourth pre-GC state (the maximum state value), and when the number exceeds a preset threshold, it indicates that there are many blocks that need to be GC, at which point the foreground garbage collection operation is triggered.

In yet another embodiment, the memory controller 210 determines whether to perform the garbage collection by monitoring a write performance of the storage device 20. When it is detected that a write speed is lower than an expected performance threshold, it may indicate that the storage space is severely fragmented, at which point the foreground garbage collection operation is triggered to organize the storage space.

The memory controller 210 may also adjust a garbage collection strategy according to different trigger conditions, for example, preferentially Garbage Collecting virtual blocks with larger pre-GC state values in an emergency to quickly release storage space.

Next, the memory controller 210 divides the processing into two parallelly executed branches:

In step S730, the memory controller 210 executes the host write command to write the data sent by the host system 10 to an effective storage space in the storage device 20.

Meanwhile, in step S740, the memory controller 210 performs the foreground garbage collection operation. Specifically, the memory controller 210 first obtains the valid data bitmap of the selected garbage collection virtual block. Then, the memory controller 210 scans all bits in the valid data bitmap to identify a plurality of first bits having a first value (e.g., “1”), and these first bits indicate that valid data is stored in corresponding data areas.

The memory controller 210 locates a plurality of first data areas in the garbage collection virtual block corresponding to the identified plurality of first bits. Subsequently, the memory controller 210 sequentially copies the valid data in these first data areas to a pre-allocated data block.

During the data copying process, the memory controller 210 may simultaneously update a corresponding logical-to-physical mapping table to record new physical addresses of this valid data in the mapping table.

After the copying of the valid data is completed, the memory controller 210 performs an erase operation on the garbage collection virtual block to restore it to an available state. At this time, all memory cells in the virtual block are reset to a preset value and may be used for subsequent data write operations. The corresponding virtual block mapping list, logical-to-physical index list, and virtual block pre-GC state table are updated/reset accordingly.

In this way, the memory controller 210 is able to efficiently complete the garbage collection operation while executing the host write command, effectively improving the overall performance of the storage device 20. Especially when the storage device 20 is nearly full, this garbage collection method based on the pre-GC state is able to quickly release storage space, ensuring the smooth progress of the host write operation.

Finally, this embodiment also provides a computer program product, comprising computer-readable code, or a non-volatile computer-readable storage medium carrying the computer-readable code. When the computer-readable code runs on a processor of the host system, the processor executes the flow steps of the above-mentioned memory management method and implements the functions of the memory controller. The computer program product may be specifically implemented by hardware, firmware, software, or a combination thereof. In an optional embodiment, the computer program product is specifically embodied as a computer storage medium, and in another optional embodiment, the computer program product is specifically embodied as a software product, such as a Software Development Kit (SDK), and so on.

Based on the above, the memory management method and the memory controller provided by the embodiments of the present disclosure may achieve the following technical effects:
First, the present disclosure adopts a virtual block pre-GC state classification mechanism, which divides virtual blocks into different pre-GC states according to the valid count, and pre-updates the valid data bitmap of high-priority virtual blocks when the storage device is idle. This pre-processing mechanism significantly reduces the mapping table lookup overhead during foreground garbage collection and improves garbage collection efficiency.
Second, the present disclosure designs a multi-level garbage collection trigger mechanism, which achieves precise control of garbage collection operations by monitoring indicators in multiple dimensions such as available space, write load, and block state distribution of the storage device. This mechanism is able to initiate foreground garbage collection at an appropriate time, which not only ensures the timely release of storage space but also avoids unnecessary garbage collection operations.
Third, the present disclosure establishes a fast index relationship between virtual blocks and their associated logical-to-physical mapping tables through the logical-to-physical index list mechanism. This design significantly reduces the overhead of looking up mapping tables when updating the valid data bitmap and improves the efficiency of bitmap updates.
Fourth, when performing foreground garbage collection, the present disclosure preferentially selects virtual blocks with the maximum pre-GC state value for processing, and quickly identifies and copies valid data based on the valid data bitmap. This method minimizes the amount of data migration and improves the speed of garbage collection.

In summary, the memory management method provided by the present disclosure significantly improves the performance of the storage device under high-load conditions, and is particularly suitable for application scenarios that require frequent data writing. By pre-updating the valid data bitmap and combining it with the pre-GC state classification mechanism, this solution effectively solves the problem of low efficiency of traditional foreground garbage collection and improves the overall operating efficiency of the storage device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, adapted for a storage device configured with a rewritable non-volatile memory module, the method comprising:
obtaining a valid count of each of a plurality of virtual blocks, wherein each of the virtual blocks comprises one or more physical blocks of the rewritable non-volatile memory module;
obtaining a pre-GC state of each of the virtual blocks according to the valid count of each of the virtual blocks;
determining an update order of a valid data bitmap of each of the virtual blocks according to the pre-GC state of each of the virtual blocks; and
selecting a target virtual block from the plurality of virtual blocks according to the update order of the valid data bitmap of each of the virtual blocks, to update a target valid data bitmap of the target virtual block by using a logical-to-physical index list corresponding to the target virtual block and a logical-to-physical mapping table corresponding to the logical-to-physical index list.

2. The memory management method as claimed in claim 1, wherein the method further comprises:
determining a garbage collection order of each of the virtual blocks according to the pre-GC state of each of the virtual blocks.

3. The memory management method as claimed in claim 1, wherein the step of obtaining the pre-GC state of each of the virtual blocks comprises:
comparing the valid count of each of the virtual blocks with a plurality of thresholds of different sizes to determine a threshold interval in which the valid count of each of the virtual blocks is located;
determining the pre-GC state of each of the virtual blocks according to the threshold interval of each of the virtual blocks,
if the valid count of a virtual block is greater than a maximum threshold among the plurality of thresholds, determining the pre-GC state of the virtual block to be a minimum pre-GC state;
if the valid count of a virtual block is smaller than a minimum threshold among the plurality of thresholds, determining the pre-GC state of the virtual block to be a maximum pre-GC state;
wherein a first virtual block corresponding to the minimum pre-GC state is determined to not need to update a corresponding first valid data bitmap, and a second virtual block corresponding to the maximum pre-GC state is determined to need to preferentially update a corresponding second valid data bitmap.

4. The memory management method as claimed in claim 3, wherein a number of the plurality of thresholds is 3, and the pre-GC state comprises a first pre-GC state, a second pre-GC state, a third pre-GC state, and a fourth pre-GC state,
wherein a valid count corresponding to the first pre-GC state is greater than a first threshold,
a valid count corresponding to the second pre-GC state is greater than a second threshold and smaller than the first threshold,
a valid count corresponding to the third pre-GC state is greater than a third threshold and smaller than the second threshold,
and a valid count corresponding to the fourth pre-GC state is smaller than a third threshold, wherein the first threshold is the maximum threshold, the third threshold is the minimum threshold, the first threshold is greater than the second threshold, and the second threshold is greater than the third threshold.

5. The memory management method as claimed in claim 1, wherein the logical-to-physical index list is used for recording an identifier of one or more logical-to-physical mapping tables associated with a corresponding virtual block, wherein a physical address of valid data stored in the corresponding virtual block is recorded in one of the one or more logical-to-physical mapping tables.

6. The memory management method as claimed in claim 1, wherein the valid data bitmap comprises a plurality of bits, each of the bits corresponds to a data area of a preset size in the virtual block, and is used for indicating whether data in the data area is valid data.

7. The memory management method as claimed in claim 6, wherein the method further comprises:
updating the target virtual block when the storage device is in an idle period,
wherein the step of updating the target valid data bitmap of the target virtual block comprises:
determining one or more target logical-to-physical mapping tables associated with the target virtual block through the logical-to-physical index list of the target virtual block;
checking whether a physical address of each data area of the target virtual block exists in the one or more target logical-to-physical mapping tables; and
updating the plurality of bits of the target valid data bitmap according to a check result of each data area, wherein the updated target valid data bitmap is stored into the rewritable non-volatile memory module.

8. The memory management method as claimed in claim 7, wherein the step of updating the plurality of bits of the target valid data bitmap comprises:
if a first physical address of a first data area of the target virtual block exists in one of the one or more target logical-to-physical mapping tables, setting a first bit corresponding to the first data area among the plurality of bits of the target valid data bitmap to a first value; and
if a second physical address of a second data area of the target virtual block does not exist in any of the one or more target logical-to-physical mapping tables, setting a second bit corresponding to the second data area among the plurality of bits of the target valid data bitmap to a second value.

9. The memory management method as claimed in claim 2, wherein determining the garbage collection order of each of the virtual blocks comprises:
when performing a foreground garbage collection during a host write operation, preferentially selecting a virtual block with the maximum pre-GC state as a garbage collection virtual block to perform garbage collection; and
secondarily selecting a virtual block with a second-largest pre-GC state as the garbage collection virtual block to perform garbage collection.

10. The memory management method as claimed in claim 9, wherein the step of performing the garbage collection comprises:
obtaining the valid data bitmap of the selected garbage collection virtual block;
copying first data of each of a plurality of first data areas corresponding to a plurality of first bits in the valid data bitmap of the selected virtual block to a data block according to the plurality of first bits; and
performing an erase operation on the garbage collection virtual block.

11. A memory controller for controlling a storage device configured with a rewritable non-volatile memory module, the memory controller comprising:
a memory interface control circuit, electrically connected to the rewritable non-volatile memory module;
a data management circuit, electrically connected to a connection interface circuit of the storage device, for receiving data and commands from a host system via the connection interface circuit;
a buffer memory, for buffering data; and
a processor, electrically connected to the memory interface control circuit, the data management circuit, and the buffer memory, wherein the processor is configured to:
obtain a valid count of each of a plurality of virtual blocks, wherein each of the virtual blocks comprises one or more physical blocks of the rewritable non-volatile memory module;
obtain a pre-GC state of each of the virtual blocks according to the valid count of each of the virtual blocks;
determine an update order of a valid data bitmap of each of the virtual blocks according to the pre-GC state of each of the virtual blocks; and
select a target virtual block from the plurality of virtual blocks according to the update order of the valid data bitmap of each of the virtual blocks, to update a target valid data bitmap of the target virtual block by using a logical-to-physical index list corresponding to the target virtual block and a logical-to-physical mapping table corresponding to the logical-to-physical index list.

12. The memory controller as claimed in claim 11, wherein the processor is further configured to:
determine a garbage collection order of each of the virtual blocks according to the pre-GC state of each of the virtual blocks.

13. The memory controller as claimed in claim 11, wherein when obtaining the pre-GC state of each of the virtual blocks, the processor is configured to:
compare the valid count of each of the virtual blocks with a plurality of thresholds of different sizes to determine a threshold interval in which the valid count of each of the virtual blocks is located;
determine the pre-GC state of each of the virtual blocks according to the threshold interval of each of the virtual blocks,
if the valid count of a virtual block is greater than a maximum threshold among the plurality of thresholds, determine the pre-GC state of the virtual block to be a minimum pre-GC state;
if the valid count of a virtual block is smaller than a minimum threshold among the plurality of thresholds, determine the pre-GC state of the virtual block to be a maximum pre-GC state;
wherein a first virtual block corresponding to the minimum pre-GC state is determined to not need to update a corresponding first valid data bitmap, and a second virtual block corresponding to the maximum pre-GC state is determined to need to preferentially update a corresponding second valid data bitmap.

14. The memory controller as claimed in claim 13, wherein a number of the plurality of thresholds is 3, and the pre-GC state comprises a first pre-GC state, a second pre-GC state, a third pre-GC state, and a fourth pre-GC state,
wherein a valid count corresponding to the first pre-GC state is greater than a first threshold,
a valid count corresponding to the second pre-GC state is greater than a second threshold and smaller than the first threshold,
a valid count corresponding to the third pre-GC state is greater than a third threshold and smaller than the second threshold,
and a valid count corresponding to the fourth pre-GC state is smaller than a third threshold, wherein the first threshold is the maximum threshold, the third threshold is the minimum threshold, the first threshold is greater than the second threshold, and the second threshold is greater than the third threshold.

15. The memory controller as claimed in claim 11, wherein the logical-to-physical index list is used for recording an identifier of one or more logical-to-physical mapping tables associated with a corresponding virtual block, wherein a physical address of valid data stored in the corresponding virtual block is recorded in one of the one or more logical-to-physical mapping tables.

16. The memory controller as claimed in claim 11, wherein the valid data bitmap comprises a plurality of bits, each of the bits corresponds to a data area of a preset size in the virtual block, and is used for indicating whether data in the data area is valid data.

17. The memory controller as claimed in claim 16, wherein the processor is further configured to:
update the target virtual block when the storage device is in an idle period,
wherein the step of updating the target valid data bitmap of the target virtual block comprises:
determining one or more target logical-to-physical mapping tables associated with the target virtual block through the logical-to-physical index list of the target virtual block;
checking whether a physical address of each data area of the target virtual block exists in the one or more target logical-to-physical mapping tables; and
updating the plurality of bits of the target valid data bitmap according to a check result of each data area, wherein the updated target valid data bitmap is stored into the rewritable non-volatile memory module.

18. The memory controller as claimed in claim 17, wherein when updating the plurality of bits of the target valid data bitmap, the processor is configured to:
if a first physical address of a first data area of the target virtual block exists in one of the one or more target logical-to-physical mapping tables, set a first bit corresponding to the first data area among the plurality of bits of the target valid data bitmap to a first value; and
if a second physical address of a second data area of the target virtual block does not exist in any of the one or more target logical-to-physical mapping tables, set a second bit corresponding to the second data area among the plurality of bits of the target valid data bitmap to a second value.

19. The memory controller as claimed in claim 12, wherein when determining the garbage collection order of each of the virtual blocks, the processor is configured to:
when performing a foreground garbage collection during a host write operation, preferentially select a virtual block with the maximum pre-GC state as a garbage collection virtual block to perform garbage collection; and
secondarily select a virtual block with a second-largest pre-GC state as the garbage collection virtual block to perform garbage collection.

20. The memory controller as claimed in claim 19, wherein when performing the garbage collection, the processor is configured to:
obtain the valid data bitmap of the selected garbage collection virtual block;
copy first data of each of a plurality of first data areas corresponding to a plurality of first bits in the garbage collection virtual block to a data block according to the plurality of first bits; and
perform an erase operation on the garbage collection virtual block.
